(19) United States
(12) Patent Application Publication
(10) Pub. No.: US 2018/0039475 A1
(43) Pub. Date: Feb. 8, 2018

(54) USER-CREATED AUDIO STATION

(71) Applicant: Panasonic Automotive Systems Company of America, Division of Panasonic Corporation of North America, PEACHTREE CITY, GA (US)

(72) Inventors: SHANTHA KUMARI RAJENDRAN, FARMINGTON HILLS, MI (US); HARSHA V. INJETI, FAYETTEVILLE, GA (US); BHASKAR KONISETTY, FARMINGTON HILLS, MI (US)

(73) Assignee: Panasonic Automatic Systems Company of America, Division of Panasonic Corporation of North America

(21) Appl. No.: 15/666,730

(22) Filed: Aug. 2, 2017

Related U.S. Application Data
(60) Provisional application No. 62/370,498, filed on Aug. 3, 2016.

(51) Int. Cl. G06F 3/16; G06F 17/30; G06F 3/0481

(52) U.S. Cl. CPC G06F 3/165; G06F 3/0481; G06F 17/30772; H04R 1/02

(57) ABSTRACT

A user-created audio station arrangement for a motor vehicle includes a plurality of sources of audio content. A user interface enables a human user to input a preference for a type of audio content to be played by an audio system of the motor vehicle. An electronic processor is communicatively coupled to the sources of audio content and to the user interface. The electronic processor receives the preference for a type of audio content from the user interface. The electronic processor searches the sources of audio content for audio content of the type preferred by the human user.

### CROSS-REFERENCE TO RELATED APPLICATION

This application claims benefit of U.S. Provisional Application No. 62/370,498 filed on Aug. 3, 2016, which the disclosure of which is hereby incorporated by reference in its entirety for all purposes.

### FIELD OF THE INVENTION

The disclosure relates to an infotainment system for a motor vehicle.

### BACKGROUND OF THE INVENTION

Currently, in-vehicle infotainment units allow users to choose the music they want by selecting the audio source. The user needs to choose between AM/FM radio, satellite radio, internet radio, USB, SD, CD, iPod, and other such media sources. All browsing for songs, genre selection, search, and listening is done after source selection. There is no provision for the user to select the genre/artist he wants to listen to, regardless of the source.

Internet radio applications such as Pandora allow user to provide an artist name and pull songs from the application's database sequentially. Apple Radio, Amazon Music and other such media applications also allow the user to listen to a specific genre station. Songs of that particular genre are played to the user.

### SUMMARY

The present invention may enable an in-vehicle infotainment system user to create his own audio station by selecting a genre, artist, etc. that he wants to listen to, regardless of the audio source. For example, in response to the user selecting “Pop” as the genre and creating an audio station, all Pop genre songs from all different sources (e.g., AM/FM radio, satellite radio, internet radio, universal serial bus (USB), secure digital (SD) card, compact disc (CD), iPod, and other such media sources) are streamed to the user, one after another. If the current source does not play the required genre, then a different source is searched for the genre and played automatically. If the user skips a song, then another song from another source may be played to the user. There may be a pre-stored or predetermined order of source search sequence, which may or may not be defined by the user. For example, a user may have preferred search order, such as satellite radio, iPod, and then FM radio, which he may store in the system, and which may be executed by the system when performing a search. The user may practically have access to an almost unlimited number of songs in the selected genre for listening, as all the different source pools of songs are combined together.

A novel feature of the invention may be the unique way that it combines songs from various different audio sources and filters out undesired songs, providing the user with songs in the category he wants.

In one embodiment, the invention comprises a user-created audio station arrangement for a motor vehicle, including a plurality of sources of audio content. A user interface enables a human user to input a preference for a type of audio content to be played by an audio system of the motor vehicle. An electronic processor is communicatively coupled to the sources of audio content and to the user interface. The electronic processor receives the preference for a type of audio content from the user interface. The electronic processor searches the sources of audio content for audio content of the type preferred by the human user.

In one embodiment, the invention comprises a method of operating an audio system of a motor vehicle, including providing a plurality of sources of audio content. A human user is enabled to engage a user interface to input a preference for a type of audio content to be played by an audio system of the motor vehicle. The preference for a type of audio content is received from the user interface. The sources of audio content are automatically searched for audio content of the type preferred by the human user.

In one embodiment, the invention comprises a motor vehicle including a loudspeaker, a plurality of sources of audio content, and a user interface enabling a human user to indicate a preference for a type of audio content to be played by an audio system of the motor vehicle. An electronic processor is communicatively coupled to the loudspeaker, to the sources of audio content, and to the user interface. The electronic processor receives the preference for a type of audio content from the user interface, and searches the sources of audio content for audio content of the type preferred by the human user. The searching is in a sequential order specified by the user via the user interface. The electronic processor causes the audio content of the type preferred by the human user to be played on the loudspeaker.

An advantage of the present invention is that it enables the user to choose and listen to a favorite program type or genre without having to select a source of the content. Music from all available sources may be consolidated or pooled by the system to effectively provide a single source. However, the user may also select the order of the individual sources in which the desired content is retrieved from.

### BRIEF DESCRIPTION OF THE DRAWINGS

A better understanding of the present invention will be had upon reference to the following description in conjunction with the accompanying drawings.

FIG. 1 is a block diagram of one embodiment of a user-created audio station arrangement of the present invention for a motor vehicle.

FIG. 2 is a block diagram of another embodiment of a user-created audio station arrangement of the present invention for a motor vehicle.

FIG. 3 is a flow chart of one embodiment of a method of the present invention for enabling a user to create an audio station.

FIG. 4 is a flow chart of one embodiment of a method of the present invention for operating an audio system of a motor vehicle.

### DETAILED DESCRIPTION OF THE PREFERRED EMBODIMENTS

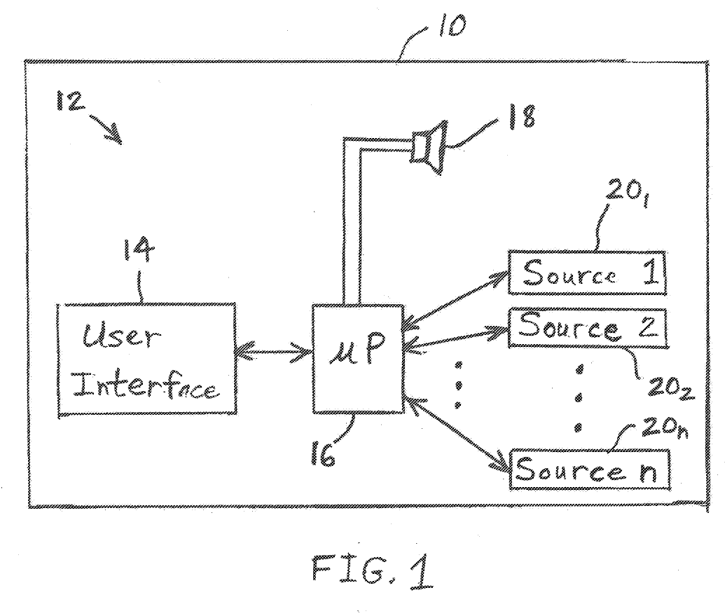

FIG. 1 illustrates a motor vehicle 10 including a user-created audio station arrangement 12 of the present invention. Arrangement 12 includes a user interface 14, an electronic processor 16, a loudspeaker 18, and audio sources 20₁, 20₂, . . . 20ₙ. User interface 14 may include a display screen, a keyboard, a dial, pushbuttons, a microphone, etc. Sources 20 may include AM/FM radio, satellite radio, internet radio, universal serial bus (USB), secure digital (SD) card, compact disc (CD), iPod, and other such media sources.

During use, a user selects via user interface 14 a musical genre and/or musical artist that he would like to hear. He may also specify a sequential order of sources 20 in which pieces of music (e.g., songs) of the selected genre/artist may be retrieved from sources 20. Upon retrieving pieces of music of the selected genre/artist from sources 20, processor 16 may audibly play the music on loudspeaker 18.

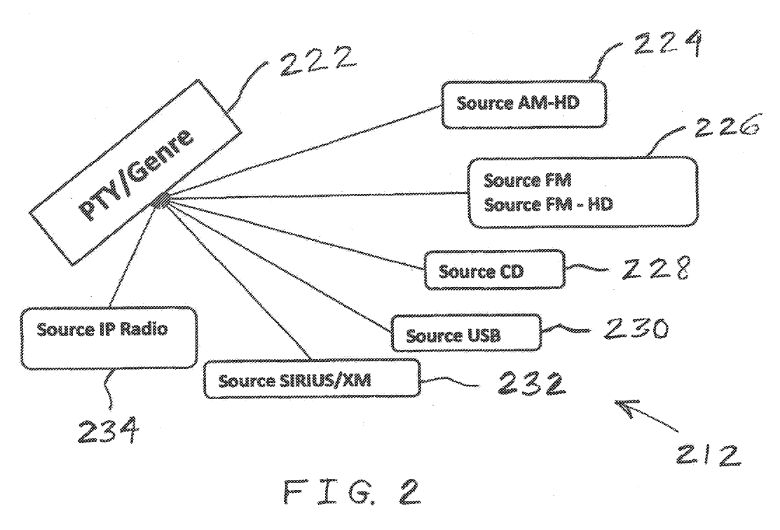

FIG. 2 illustrates another embodiment of a user-created audio station arrangement 212 of the present invention for a motor vehicle. The user may employ arrangement 212 to create a genre-based music play list for an audio system. Pieces of music of a user-selected genre or program type (PTY) in block 222 may be retrieved from various audio sources, including digital AM radio 224, FM radio 226, which may also be digital, a compact disc 228, a universal serial bus 230, satellite radio 232, and internet radio 234, for example.

User-created audio station arrangement 212 may enable a user to select, from multiple sources, songs or a station of a particular genre or program type. For example, if the user is interested in Pop type music, then the user selects the Pop genre. Internally, arrangement 212 queries the database in the form of sources 224, 226, 228, 230, 232 and 234 and plays the content from the stations that broadcast Pop music, or from other sources that include Pop music.

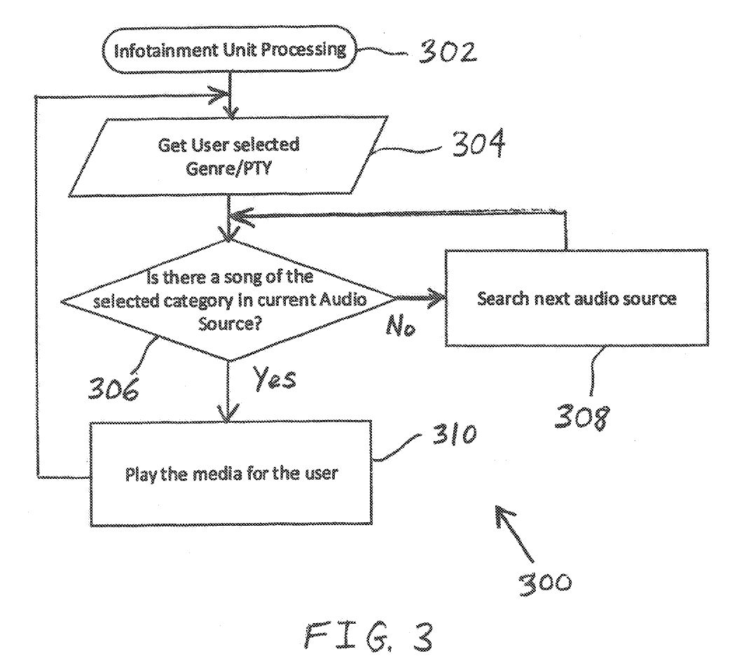

FIG. 3 illustrates one embodiment of a method 300 of the present invention for enabling a user to create an audio station for use within a motor vehicle. Method 300 includes infotainment unit processing (step 302), which may include receiving a user-selected genre or program type (step 304). For example, a user may enter an identification of his preferred musical genre, musical artist or program type (e.g., top 40 Pop hits, jazz, etc.) into arrangement 12 via user interface 14.

Next, in step 306, it is determined whether there is a piece of music of the user-selected category in the current audio source. For example, if the user is currently listening to a talk radio format on digital AM radio from source 224, and he indicates that he would like to listen instead to something in the category of jazz music, then processor 16 may search the text information broadcasted by the available digital AM radio stations to ascertain whether any of the text information states that the associated digital AM radio station is broadcasting jazz music. If not, then in step 308 another audio source is searched. For example, processor 16 may randomly pick one of the other audio sources 226, 228, 230, 232 or 234 to search for jazz music. Alternatively, a sequential order in which the audio sources are to be searched may be predetermined and stored in the order of: decreasing audio quality; decreasing reliability; decreasing or increasing time since the source was last listened to; increasing time required to search the source for the desired music; decreasing likelihood of having the particular, desired category of music; decreasing total number of songs available; or decreasing percentage of time that content from the audio source has been listened to within the motor vehicle within a previous particular time period. Alternatively, the user may specify a sequential order in which audio sources 224, 226, 228, 230, 232 and 234 are to be searched. After the next audio source is searched in step 308, operation returns to step 306. However, if it is determined in step 306, that there is indeed a piece of music of the user-selected category in the current audio source, then that piece of musical content of the user-selected category is played for the user (step 310). Operation then returns to step 304.

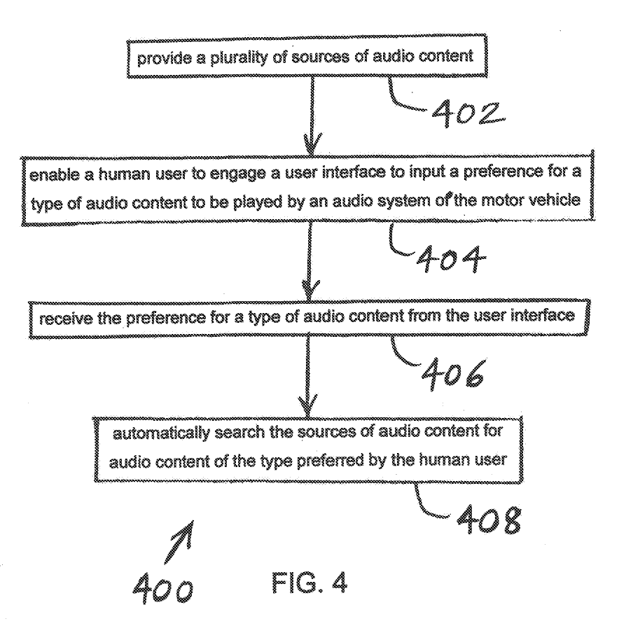

FIG. 4 illustrates one embodiment of a method 400 of the present invention for operating an audio system of a motor vehicle. In a first step 402, a plurality of sources of audio content are provided. For example, audio sources 20₁, 20₂, . . . 20ₙ may be provided in motor vehicle 10. Next, in step 404, a human user is enabled to engage a user interface to input a preference for a type of audio content to be played by an audio system of the motor vehicle. For example, a user may select via user interface 14 a musical genre and/or musical artist that he would like to hear.

In a next step 406, the preference for a type of audio content is received from the user interface. For example, processor 16 may receive the user's selected musical genre and/or musical artist from user interface 14.

In a final step 408, the sources of audio content are automatically searched for audio content of the type preferred by the human user. For example, processor 16 may automatically search audio sources 20₁, 20₂, . . . 20ₙ for pieces of music associated with the user's selected musical genre and/or musical artist.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A user-created audio station arrangement for a motor vehicle, the arrangement comprising:
a plurality of sources of audio content;
a user interface configured to enable a human user to input a preference for a type of audio content to be played by an audio system of the motor vehicle; and
an electronic processor communicatively coupled to the sources of audio content and to the user interface, the electronic processor being configured to:
receive the preference for a type of audio content from the user interface; and
search the sources of audio content for audio content of the type preferred by the human user.

2. The arrangement of claim 1 further comprising a loudspeaker communicatively coupled to the electronic processor, the electronic processor being configured to:
receive the audio content of the type preferred by the human user from one of the sources of audio content; and
cause the received audio content to be played on the loudspeaker.

3. The arrangement of claim 1 wherein the preferred type of audio content comprises a genre of music or music recorded by a particular musical artist.

4. The arrangement of claim 1 wherein the electronic processor is configured to search the sources of audio content in a sequential order specified by the human user.

5. The arrangement of claim 1 wherein the sources of audio content comprise at least one of AM/FM radio, a compact disc, a universal serial bus, satellite radio, internet radio, a secure digital card, and an iPod.

6. The arrangement of claim 1 wherein the electronic processor is configured to search the sources of audio content in an order of decreasing audio quality or decreasing reliability of the sources of audio content.

7. The arrangement of claim 1 wherein the electronic processor is configured to search the sources of audio content in an order dependent upon respective periods of time since content from each of the sources was last played within the motor vehicle.

8. A method of operating an audio system of a motor vehicle, the method comprising:
providing a plurality of sources of audio content;
enabling a human user to engage a user interface to input a preference for a type of audio content to be played by an audio system of the motor vehicle;
receiving the preference for a type of audio content from the user interface; and
automatically searching the sources of audio content for audio content of the type preferred by the human user.

9. The method of claim 8 further comprising:
receiving the audio content of the type preferred by the human user from one of the sources of audio content; and
causing the received audio content to be played on a loudspeaker within the motor vehicle.

10. The method of claim 8 wherein the preferred type of audio content comprises a genre of music, music recorded by a particular musical artist, or a program type.

11. The method of claim 8 further comprising:
enabling the human user to engage the user interface to input a sequential order in which the sources of audio content are to be searched; and
receiving the sequential order from the user interface, wherein the automatically searching comprises searching the sources of audio content in the sequential order specified by the human user.

12. The method of claim 8 wherein the sources of audio content comprise at least one of AM/FM radio, a compact disc, a universal serial bus, satellite radio, internet radio, a secure digital card, and an iPod.

13. The method of claim 8 wherein the automatically searching comprises searching the sources of audio content in an order of decreasing audio quality or decreasing reliability of the sources of audio content.

14. The method of claim 8 wherein the automatically searching comprises searching the sources of audio content in an order dependent upon respective periods of time since content from each of the sources was last played within the motor vehicle.

15. A motor vehicle, comprising:
a loudspeaker;
a plurality of sources of audio content;
a user interface configured to enable a human user to indicate a preference for a type of audio content to be played by an audio system of the motor vehicle; and
an electronic processor communicatively coupled to the loudspeaker, to the sources of audio content, and to the user interface, the electronic processor being configured to:
receive the preference for a type of audio content from the user interface;
search the sources of audio content for audio content of the type preferred by the human user, the searching being in a sequential order specified by the user via the user interface; and
cause the audio content of the type preferred by the human user to be played on the loudspeaker.

16. The motor vehicle arrangement of claim 15 wherein the electronic processor is configured to:
receive from one of the audio sources the audio content of the type searched for by the electronic processor, and
cause the received audio content to be played on the loudspeaker.

17. The motor vehicle of claim 15 wherein the preferred type of audio content comprises a genre of music, music recorded by a particular musical artist, or a program type.

18. The motor vehicle of claim 15 wherein the sequential order specified by the human user is in order of decreasing percentage of time that content from the audio source has been listened to within the motor vehicle within a previous particular time period.

19. The motor vehicle of claim 15 wherein the sources of audio content comprise at least one of AM/FM radio, a compact disc, a universal serial bus, satellite radio, internet radio, a secure digital card, and an iPod.

20. The motor vehicle of claim 15 wherein the sequential order specified by the human user is an order of decreasing audio quality or decreasing reliability of the sources of audio content.
